(19) United States
(12) Patent Application Publication
(10) Pub. No.: US 2024/0258571 A1
(43) Pub. Date: Aug. 1, 2024

(54) COMPOSITE SEMI-SOLID ELECTROLYTE AND BATTERIES COMPRISING THE SAME

(71) Applicant: Celgard, LLC, Charlotte, NC (US)

(72) Inventors: Zhengming Zhang, Rock Hill, SC (US); Wenbin Yin, Charlotte, NC (US); Jialin Mao, Charlotte, NC (US)

(21) Appl. No.: 18/627,800

(22) Filed: Apr. 5, 2024

Related U.S. Application Data
(63) Continuation-in-part of application No. PCT/US24/10327, filed on Jan. 4, 2024.
(60) Provisional application No. 63/437,181, filed on Jan. 5, 2023.

(51) Int. Cl. H01M 10/0568; H01M 10/0567; H01M 10/0569

(52) U.S. Cl. CPC H01M 10/0568; H01M 10/0567; H01M 10/0569; H01M 2300/0025; H01M 2300/0094

(57) ABSTRACT

2. A composite for forming an improved semi-solid state electrolyte. The composite has a layer formed including lithium metaphosphate (LiPO₃). The layer may include a mixture of LiPO₃ and PEO. The composite may be wet with liquid electrolyte to form the semi-solid state electrolyte. When used in a semi-solid state battery, the semi-solid state electrolyte provides beneficial results, including improved cycle life and less lithium dendrite growth. Another composite for forming an improved semi-solid state electrolyte has a layer formed including LiTaO₃ and LiNbO₃. Yet another composite has a single layer formed to include a mixture of a polyethylene oxide and a lithium-containing salt, including a lithium salt including niobium, tantalum, or mixtures thereof. Such composites may be wet with liquid electrolyte to form the semi-solid state electrolyte. When used in a semi-solid state battery, the semi-solid state electrolyte provides beneficial results, including improved cycle life and less lithium dendrite growth.

### RELATED APPLICATION DATA

This Application is a continuation in part to PCT Application No. PCT/US24/10327, filed Feb. 27, 2024, which claims priority to U.S. Provisional Application No. 63/437,181, filed Jan. 5, 2023, and is incorporated herein by reference.

### FIELD

The technology relates to a semi-solid state electrolyte composite for use in a battery, especially a semi-solid state battery, such as Li semi-solid state battery.

### BACKGROUND

Solid state electrolyte (SSE) batteries, such as Li solid state electrolyte (SSE) batteries, have some known issues. For example, most of the elastic SSEs may react with a Li metal anode to form very resistive layers at the interface of the anode and the SSE. This is illustrated in FIG. 1.

For crystal or glassy SSEs, even the cathode-SSE interface can become a problem. With crystal or crystalline SSEs, even more problems occur, especially if the anode and/or cathode is made of a softer material than the crystalline SSEs. The crystalline or glassy SSEs may damage the anode and/or cathode material, which is particularly problematic when the anode is made of soft and reactive lithium (Li) metal.

Another issue is potential Li deposition at the interface of an SSE and lithium metal, which may lead to dendrites and soft or hard shorts in the battery. An exemplary SSE is shown in FIG. 2.

Another issue with SSE batteries is that the solid electrolyte fails to achieve what is easy for liquid electrolytes, i.e., to infiltrate all the empty spaces in a battery cell in order to boost performance and promote longer cycle life.

Semi-solid-state (S-SSE) batteries are known to address some of the aforementioned issues of SSE batteries. As understood in the art, S-SSE batteries combine both solid and liquid electrolyte components. Though S-SSE batteries have addressed many of the issues of SSE batteries, there is always a desire for improved performance, which includes longer cycle life.

### SUMMARY

In accordance with at least certain embodiments, aspects or objects, a composite for forming an improved semi-solid state electrolyte and/or an improved semi-solid state electrolyte battery or cell is provided or disclosed. The composite may preferably have a layer formed including lithium metaphosphate (LiPO₃). The layer may include a mixture of LiPO₃ and PEO. At least a portion of the composite may be wet with liquid electrolyte to form the semi-solid state electrolyte. When used in a semi-solid state battery, the semi-solid state electrolyte provides beneficial results, including improved cycle life and less lithium dendrite growth.

In one aspect, a composite that may be used to form a semi-solid state electrolyte is disclosed. The composite comprises a support and at least one layer on at least one side formed to include a mixture of a lithium-containing salt and a compound according to formula (1):

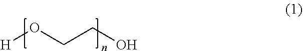

wherein n is an integer from 1-100, 1-50, or 1-10. It is contemplated that there could be one layer on one side, one layer on each side, two layers on one side, a coating over the layer, a coating under the layer, or combinations thereof. For example, the substrate can be coated on one or both sides with a mixture of a lithium-containing salt and a compound.

The support may be a microporous membrane, a polyolefin microporous membrane, or a dry-process polyolefin microporous membrane.

The lithium-containing salt may comprise, in addition to lithium, niobium, tantalum, or combinations thereof. In some embodiments, the lithium-containing salt may be or comprise LiTaO₃, LiNbO₃, LiPO₃, or combinations thereof.

A weight ratio of an amount of the compound according to formula (1) and the amount of the lithium-containing salt in the layer may be 1:100 to 100:1, or 1:1 to 1:50, 1:1 to 1:40, 1:1 to 1:30, 1:1 to 1:20, or 1:1 to 1:10. The compound of formula (1) may preferably be polyethylene oxide (PEO) having a molecular weight between 200 to 6,000,000, or 200 to 4,000,000, or 100,000 to 4,000,000, or 100,000 to 1,000,000, or 100,000 to 600,000 g/mol.

In another aspect, a semi-solid state electrolyte formed from the composite described herein above is disclosed. In the semi-solid state electrolyte, the layer of the composite that comprises the lithium-containing salt and the compound according to formula (1) is wet with electrolyte. The electrolyte may comprise a lithium-containing salt and an organic solvent. The lithium salt may be selected from LiPF₆, LiClO₄, LiBF₄, LiAsF₆, LiBOB, LIODFB, LiDFB, LiTFSl, LiFSl, or combinations thereof, and the organic solvent may be selected from ethylene carbonate (EC), dimethyl carbonate (DMC), diethyl carbonate (DEC), ethyl methyl carbonate (EMC), propylene carbonate (PC), a carboxylate solvent, a sulfite solvent, a fluorinated solvent, or combinations thereof.

In another aspect, a cell comprising an anode, a cathode, and a semi-solid state electrolyte as described herein is disclosed. The cell may exhibit improved performance including a charge capacity retention of 80% or more after 250 cycles or more, a capacity retention of 80% or more after 300 cycles, and markedly reduced lithium deposition.

In another aspect, a composite comprises a support; and a layer formed on at least one side of the support, wherein the layer is formed including lithium metaphosphate (LiPO₃).

In another aspect, a composite comprises a support; and a layer formed on at least one side of the support, wherein the layer is formed including a combination of LiPO₃ and PEO.

In another aspect, a composite comprises a support; and a layer formed on at least one side of the support, wherein the layer is formed including LiTaO₃, LiNbO₃, or a combination thereof.

### BRIEF DESCRIPTION OF THE DRAWINGS

FIG. 1 is a schematic drawing showing issues of typical solid-state batteries as described herein.

FIG. 2 is a schematic drawing showing issues of typical solid-state batteries as described herein.

FIG. 3 includes cycling data for inventive and comparative examples described herein.

FIG. 4 is a photo showing lithium deposition for inventive and comparative examples described herein.

FIG. 5 includes capacity retention data for inventive and comparative examples described herein.

FIG. 6 are photos for the inventive and comparative examples of FIG. 5.

FIG. 7 includes Coulombic efficiency data for inventive and comparative examples described herein.

FIG. 8 includes Lithium stripping and deposition test data for inventive and comparative examples described herein.

FIG. 9 are photos for the inventive and comparative examples of FIG. 8.

### DETAILED DESCRIPTION

Accordingly, embodiments described herein can be understood more readily by reference to the following detailed description, examples, and figures. Elements, apparatus, and methods described herein, however, are not limited to the specific embodiments presented in the detailed description, examples, and figures. It should be recognized that the exemplary embodiments herein are merely illustrative of the principles of the invention. Numerous modifications and adaptations will be readily apparent to those of skill in the art without departing from the spirit and scope of the invention/claims.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” or “5 to 10” or “5-10” should generally be considered to include the end points 5 and 10.

Further, when the phrase “up to” is used in connection with an amount or quantity; it is to be understood that the amount is at least a detectable amount or quantity. For example, a material present in an amount “up to” a specified amount can be present from a detectable amount and up to and including the specified amount.

Additionally, in any disclosed embodiment, the terms “substantially,” “approximately,” and “about” may be substituted with “within [a percentage] of” what is specified, where the percentage includes 0.1, 1, 5, and 10 percent.

Many different arrangements of the various components and/or steps depicted and described, as well as those not shown, are possible without departing from the scope of the claims below. Embodiments of the present technology have been described with the intent to be illustrative rather than restrictive. Alternative embodiments will become apparent from reference to this disclosure. Alternative means of implementing the aforementioned can be completed without departing from the scope of the claims below. Certain features and subcombinations are of utility and can be employed without reference to other features and subcombinations and are contemplated within the scope of the claims.

Disclosed herein are composites that may be used to form an improved semi-solid state electrolyte. The semi-solid state electrolyte(s) of the invention may be used to form: a cell comprising an anode, a cathode, and the improved semi-solid state electrolyte(s); or a semi-solid state battery comprising an anode, a cathode, and the improved semi-solid-state electrolyte(s). When used in a cell, the cell exhibits improved properties, including improved cycle life, reduced lithium deposition. Improved cycle life can mean a greater capacity retention after a given number of cycles.

### Composite

The composites described herein may comprise, consist of, or consist essentially of the following: (1) a support; and (2) a layer formed on at least one side of the support. The layer may be formed on both sides of the support. The layer is formed such that the layer is a single layer that comprises, consists of, or consists essentially of a mixture of a lithium-containing salt and a compound according to formula (1):

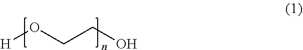

wherein n is an integer from 1 to 100, from 1 to 50, or from 1 to 10.

The lithium-containing salt may comprise, in addition to lithium, niobium, tantalum, or both niobium and tantalum. In some embodiments, the layer may comprise LiNbO₃. In some embodiments, the layer may comprise LiTaO₃. In some embodiments, the layer may comprise both of LiTaO₃ and LiNbO₃.

A weight ratio of an amount of the compound according to formula (1) and the amount of the lithium-containing salt in the layer may be 1:100 to 100:1, or 1:1 to 1:50, 1:1 to 1:40, 1:1 to 1:30, 1:1 to 1:20, or 1:1 to 1:10.

In some embodiments, the support may be a nanoporous, mesoporous, or microporous membrane. A microporous membrane may be a membrane having an average pore size from 0.01 micron to 1 micron.

In some embodiments the microporous membrane may be a polyolefin-containing microporous membrane, wherein the polyolefin may be selected from polyethylene homopolymers, polypropylene homopolymers, co-polymers of polyethylene, co-polymers of polypropylene, or combinations of the foregoing.

In some embodiments, the support may be a dry-process membrane. As understood by those skilled in the art, a dry-process membrane is formed without the use of pore forming solvents, diluents, or oils. Membranes formed with solvents, oils, or diluents are considered to be wet-process membranes. In some embodiments, the dry-process membranes described herein include only polymer. They do not include any pore-forming agents, such as particulate pore-forming agents or nucleators that assist in the formation of pores. One example of membranes formed with particulate pore-forming agents are beta-nucleated biaxially oriented polypropylene membranes (BNBOPP) membranes. An example of membranes formed without solvents, oils, diluents, or particulate pore-forming agents are membranes formed by the Celgard® dry-stretch process. Membranes made by the Celgard® dry-stretch process have a unique structure compared to wet-process and BNBOPP membranes.

### Semi-Solid State Electrolyte

The improved semi-solid state electrolyte described herein may comprise any composite as described above, wherein the layer comprising a mixture of a lithium-containing salt and a compound according to formula (1) is wet with electrolyte.

In some embodiments, the electrolyte used may comprise, consist of, or consist essentially of a lithium-containing salt and an organic solvent. The lithium-containing salt is selected from LiPF₆, LiClO₄, LiBF₄, LiAsF₆, LIBOB, LIODFB, LiDFB, LiTFSl, LIFSl, or combinations thereof. The organic solvent may be selected from ethylene carbonate (EC), dimethyl carbonate (DMC), diethyl carbonate (DEC), ethyl methyl carbonate (EMC), propylene carbonate (PC), a carboxylate solvent, a sulfite solvent, a fluorinated solvent, or combinations thereof. The electrolyte, in some embodiments, may further contain an electrolyte additive.

### Cell or Battery

In a further aspect, a cell or battery comprising an anode, a cathode, and a semi-solid state electrolyte as described herein is formed. The cell or battery exhibits, among other things, improved cycle life and reduced lithium deposition compared to prior cells or batteries including a semi-solid state electrolyte. For example, a capacity retention of more than 80% is maintained for more than 200 cycles, more than 250 cycles, or more than 300 cycles. As shown in the Examples herein, markedly reduced lithium deposition is observed as well. Less lithium deposition means less dendrite growth, less likelihood of shorts, and overall improved battery safety and performance.

In a further aspect, object, or embodiment, a preferred composite for forming an improved semi-solid state electrolyte is provided or disclosed. The composite has a single layer or coating formed to include a mixture of a polyethylene oxide and a lithium-containing salt, including a lithium salt including niobium, tantalum, or mixtures thereof. The composite may be wet with liquid electrolyte to form the semi-solid state electrolyte. When used in a semi-solid state battery, the semi-solid state electrolyte provides beneficial results, including improved cycle life and less lithium dendrite growth.

In a still further aspect, object, or embodiment, an improved semi-solid state electrolyte includes at least one layer including a mixture of a polyethylene oxide and a lithium-containing salt, including a lithium salt including niobium, tantalum, or mixtures thereof. The at least one layer may be wet with liquid electrolyte to form the semi-solid state electrolyte. When used in a semi-solid state battery, the semi-solid state electrolyte provides beneficial results, including improved cycle life and/or less lithium dendrite growth.

### SSE Composite Separator: Lithium Metaphosphate (LiPO₃)

In still yet another aspect, object, or embodiment of the invention, lithium metaphosphate (LiPO₃) is coated on at least one side of a wettable separator for a semi-solid-state electrolyte.

LiPO₃ functions as a good ionic conductive layer which can promote Li ion movement.

There is a synergistic effect of further increasing Li-ion ionic conductivity with the combination of LiPO₃ and PEO. Once mixed, LiPO₃ and PEO components can be applied on one side or both sides on a wettable separator such that the LiPO₃ and PEO are present on one side or both sides on a wettable separator. Without an ionic conductivity layer coating, Li metal can easily be corroded by traditional electrolyte and poor ionic conductivity of separator will have Li dentrite formation and growth, and cycling fading. The layers structure with the mixture of PEO with LiPO₃ can help the Li deposition suppression and increases life cycle. It can absorb the electrolyte and form semi-solid state electrolyte.

In an aspect of the invention, the ratio range of PEO to LiPO₃ is from 1:99 to 99:1.

The PEO and LiPO₃ mixture is preferably coated on a EWS (enhanced wettable separator, i.e., primed, coated, treated, corona-treated, plasma-treated, UV-grafting, PO₃-grafted separator, etc.) or a PWS (permanent wettable separator, i.e., PVDF coating, PMMA coating, PEO solvent coating, etc.). The PEO and LiPO₃ mixture coating layer is preferably facing the anode to provide enough ionic conductivity.

The other side of the EWS or PWS is preferably coated with Al₂O₃/boehmite or other ceramic coating, or PVDF coating to face cathode side to suppress high voltage oxidation. EWS and PWS are suitable with high concentration Li ion electrolyte which is used for Li metal batteries.

An advantage of this PEO and LiPO₃ coated separator is its extremely high ionic conductivity, longer cycle life and less Li dentrite formation and growth.

### Examples

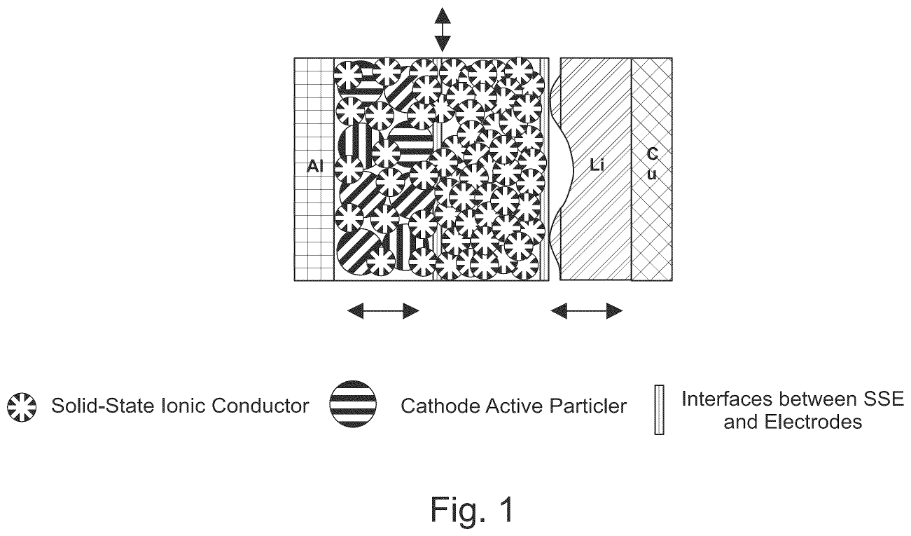

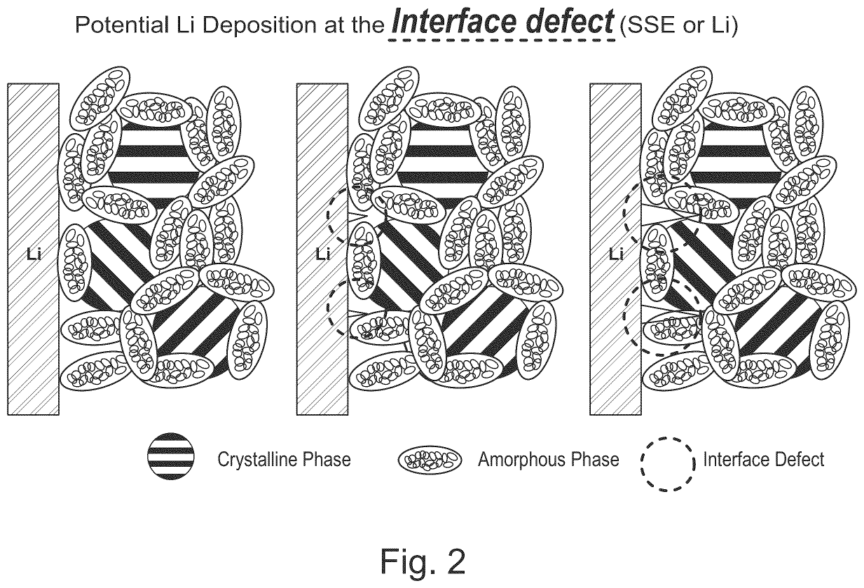

With reference to FIGS. 1-4, inventive Examples were prepared where a weight ratio of PEO to lithium niobate was 1:1 to 1:10.

Inventive Composite (single mixed layer): In this example, a mixture of a polyethylene oxide (PEO), lithium niobate (LiNbO₃), and a solvent was provided on one side of a trilayer polyolefin microporous membrane comprising, in this order, a polypropylene (PP)-layer, a polyethylene (PE)-layer, and a PP-layer. The weight ratio of PEO to lithium niobate is 1:7.

Comparative Composite (two separate layers): In this example, one layer of lithium niobate (LiNbO₃) and then a separate layer of PEO were formed on one side of a trilayer polyolefin microporous membrane.

The PEO in the Comparative Example is the same as that used in the Inventive Example. The trilayer membrane used in the Comparative and Inventive Examples is also the same. Finally, the weight ratio of PEO: LiNbO₃ is the same in each example.

Inventive Semi-Solid-State Electrolyte: to form the inventive semi-solid state electrolyte, the Inventive Composite was wet with electrolyte (1M LiPF₆, EC/EMC 3:7 vol %). The JIS Gurley of the Inventive semi-solid state electrolyte was measured and found to be about 34,000 seconds. Gurley is defined as the Japanese Industrial Standard (JIS) Gurley and is measured using the OHKEN permeability tester. JIS is defined as the time in seconds required for 100 cc of air to pass through one square inch of film at a constant pressure of 4.9 inches of water.

Comparative Semi-Solid-State Electrolyte: to form the comparative semi-solid state electrolyte, the comparative Composite was wet with electrolyte (1M LiPF₆, EC/EMC 3:7 vol %). The JIS Gurley of the comparative semi-solid state electrolyte was measured, and it was found to have an infinite Gurley, which is unfavorable to many battery manufacturers.

Coin cells were manufactured: some using the inventive semi-solid state electrolyte, some using the comparative semi-solid state electrolyte, and some using only the trilayer polyolefin microporous membrane mentioned above. Each coin cell used the same anode and cathode material. The anode material is Li-metal, and the cathode material is NMC-523. In the coin cells using only the trilayer polyolefin microporous membrane, the liquid electrolyte used was 1M LiPF₆, EC/EMC 3:7 vol %.

To obtain cycling measurements, charge the coin cell to 4.2 volts, c/5-current, and discharge at c/5 to 3 volts.

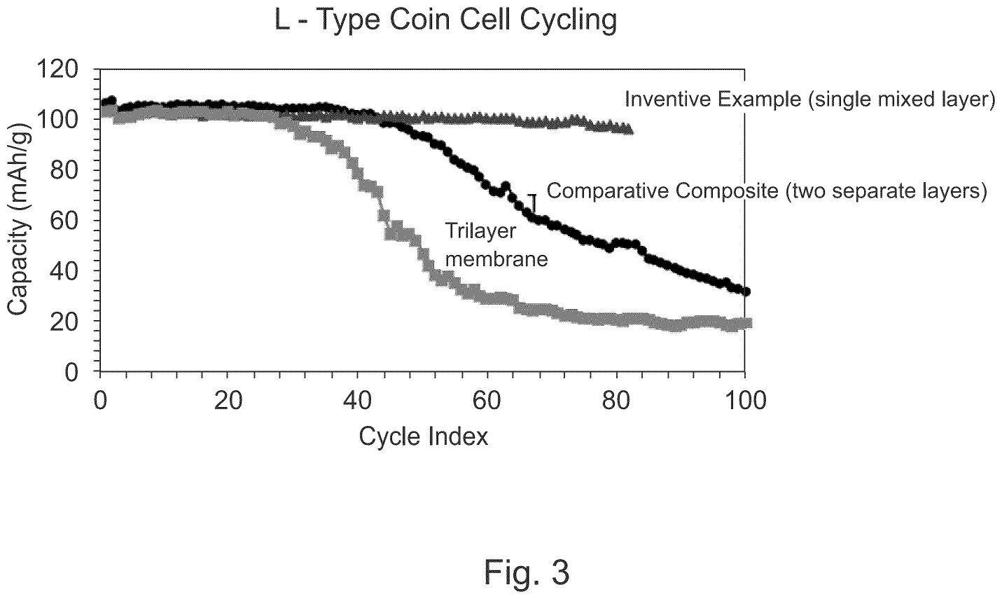

FIG. 3 shows that the Inventive Composite (single mixed layer) exhibits improved capacity retention over the same number of cycles compared to the Comparative Composite (two separate layers), and the trilayer microporous membrane itself (no coating). At 80 cycles, the capacity of the Inventive Composite is nearly twice that of the Comparative Composite.

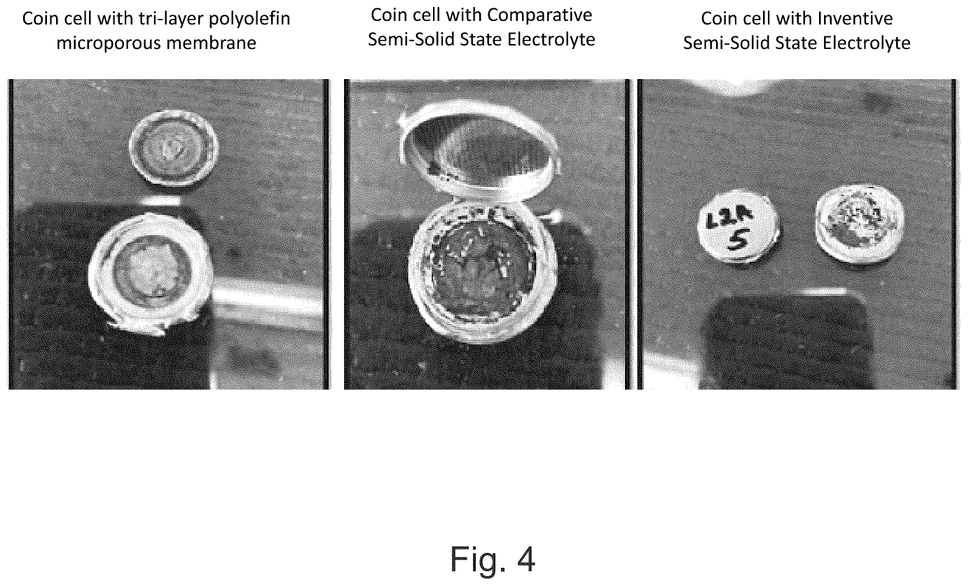

FIG. 4 shows that the Inventive Composite has less lithium deposition than the comparative composite, and the trilayer membrane itself (no coatings). For the trilayer membrane, deposition was thick and appeared yellow.

### JIS Gurley

Gurley is defined as the Japanese Industrial Standard (JIS) Gurley and is measured using the OHKEN permeability tester. JIS is defined as the time in seconds required for 100 cc of air to pass through one square inch of film at a constant pressure of 4.9 inches of water. Thickness

Thickness is measured using coating gauge, SEM or the Emveco Microgage 210-A precision micrometer according to ASTM D374. Thickness values are reported in units of microns, μm.

### Pore Size

Pore size is measured using the Aquapore available through PMI (Porous Materials Inc.). Pore size is expressed in microns, μm.

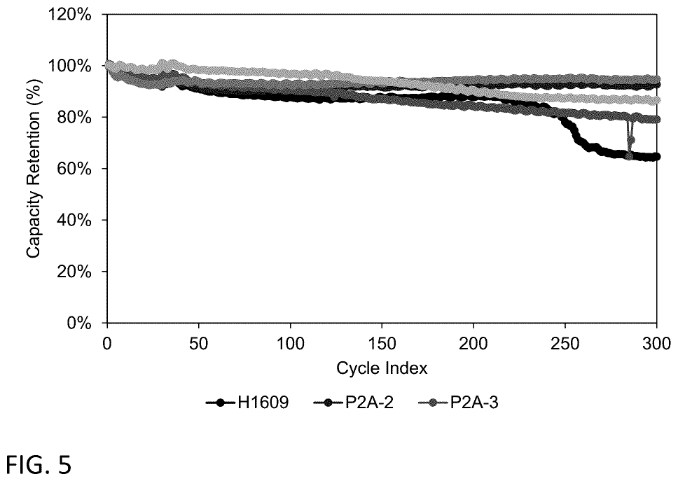

With reference to FIGS. 5-9, other inventive Examples were prepared with PEO and LiPO₃ mixture coating layer.

FIG. 5 includes capacity retention data for inventive and comparative examples described herein.

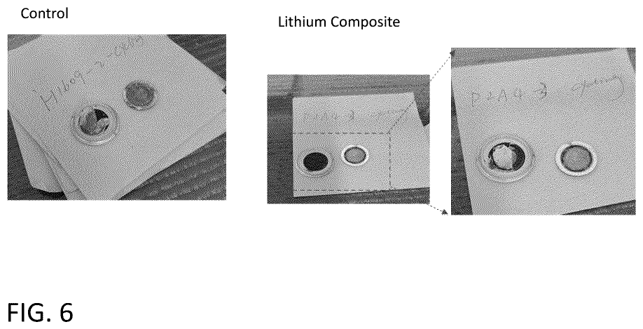

FIG. 6 are photos for the inventive and comparative examples of FIG. 5.

As shown in FIGS. 5 and 6, Li metal+composite separator of the invention can reach more than 95% capacity retention above 300 cycles, No dead Li was generated on the separator.

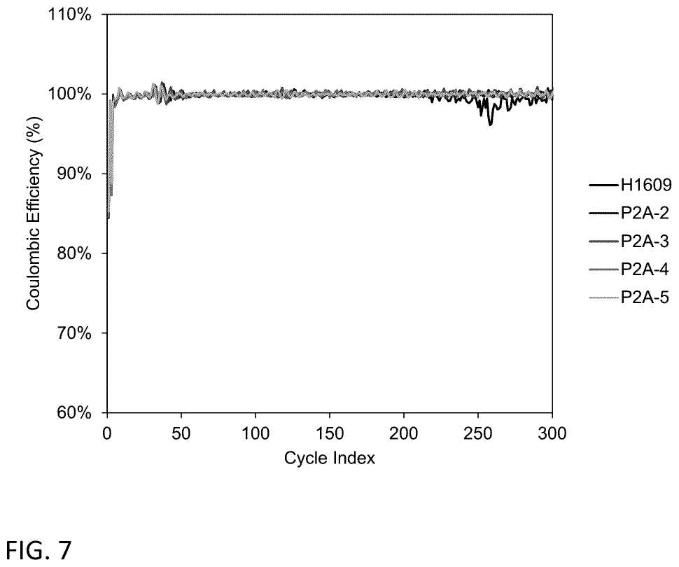

FIG. 7 includes Coulombic efficiency data for inventive and comparative examples described herein.

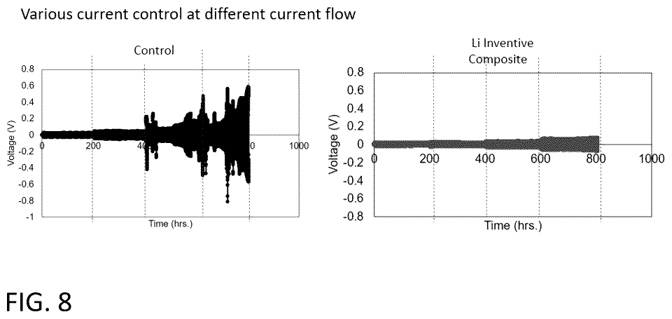

FIG. 8 includes Lithium stripping and deposition test data for inventive and comparative examples described herein.

As shown in FIG. 8, Li metal+composite separator of the invention+Li metal can tolerate high current flow without Li deposition.

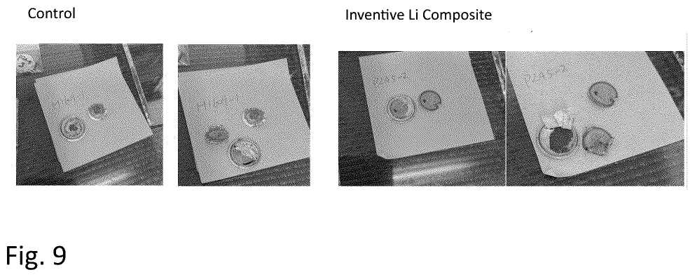

FIG. 9 are photos for the inventive and comparative examples of FIG. 8.

In accordance with at least certain embodiments, aspects or objects, a composite for forming an improved semi-solid state electrolyte is provided or disclosed. The composite may preferably have a layer formed including lithium metaphosphate (LiPO₃). The layer may include a mixture of LiPO₃ and PEO. At least a portion of the composite may be wet with liquid electrolyte to form the semi-solid state electrolyte. When used in a semi-solid state battery, the semi-solid state electrolyte provides beneficial results, including improved cycle life and less lithium dendrite growth.

Another composite for forming an improved semi-solid state electrolyte has a layer formed including LiTaO₃ and LiNbO₃. Yet another composite has a single layer formed to include a mixture of a polyethylene oxide and a lithium-containing salt, including a lithium salt including niobium, tantalum, or mixtures thereof. Such composites may be wet with liquid electrolyte to form the semi-solid state electrolyte. When used in a semi-solid state battery, the semi-solid state electrolyte provides beneficial results, including improved cycle life and less lithium dendrite growth.

Other embodiments, aspects or objects may be contemplated based on the present description, drawings and/or claims.

It should be recognized that the exemplary embodiments herein are merely illustrative of the principles of the invention. Numerous modifications and adaptations will be readily apparent to those of skill in the art without departing from the spirit and scope of the invention/claims.

1-27. (canceled)

28. A composite comprising:
a support; and
a layer formed on at least one side of the support, wherein the layer is formed including lithium metaphosphate (LiPO₃).

29. The composite of claim 28, wherein the support is a microporous membrane.

30. The composite of claim 29, wherein the support is a polyolefin microporous membrane.

31. A composite comprising:
a support; and
a layer formed on at least one side of the support, wherein the layer is formed including a combination of LiPO₃ and PEO.

32. The composite of claim 31, wherein the combination is a mixture.

33. The composite of claim 31, wherein the support is a microporous membrane.

34. The composite of claim 33, wherein the microporous membrane is a polyolefin microporous membrane.

35. The composite of claim 31, wherein PEO to LiPO₃ is in a ratio range from 1:99 to 99:1.

36. The composite of claim 31, wherein LiPO₃ and PEO are present on both sides of the support.

37. The composite of claim 31, wherein

38. A semi-solid state electrolyte comprising the composite of claim 28, wherein the layer is wet with liquid electrolyte.

39. A cell comprising an anode, a cathode, and the semi-solid state electrolyte of claim 11 comprising the composite of any of the preceding claims.

40. The cell of claim 39, wherein the Lithium containing layer of the composite faces the anode.

41. The cell of claim 39, wherein the composite of the semi-solid state electrolyte has a coating of Al2O3/boehmite, other ceramic coating, or PVDF.

42. The cell of claim 41, wherein the coating of Al2O3/boehmite, other ceramic coating, or PVDF faces the cathode.

43. Use of lithium metaphosphate (LiPO3) to improve capacity retention in a cell or battery, to reduce lithium deposition such as to reduce lithium dendrite growth, in a cell or battery, or both.

44. Use according to claim 43, wherein the LiPO3 is applied to a support and optionally wherein the LiPO3 forms part of a semi-solid state electrolyte.

45. Use of LiPO3 and PEO to improve capacity retention in a cell or battery, to reduce lithium deposition such as to reduce lithium dendrite growth, in a cell or battery, or both.

46. Use according to claim 45, wherein the mixture is applied to a support and optionally wherein the mixture forms part of a semi-solid state electrolyte.

47. A composite comprising:
a support; and
a layer formed on at least one side of the support, wherein the layer is formed such that it includes a mixture of at least one lithium-containing salt and at least one 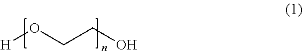
compound according to formula (1)
wherein n is an integer from 1 to 100, wherein a weight ratio of the compound according to formula (1) to the lithium-containing salt is 1:100 to 100:1, and may be 1:1 to 1:10.

48. The composite of claim 47, wherein the support is a microporous membrane.

49. The composite of claim 48, wherein the support is a polyolefin microporous membrane.

50. The composite of claim 49, wherein the support is a dry-process polyolefin microporous membrane.

51. The composite of claim 47, wherein n is 1-50.

52. The composite of claim 47, wherein n is 1-10.

53. The composite of claim 28, wherein the lithium-containing salt comprises a metal selected from Nb, Ta, P, or combinations thereof.

54. The composite of claim 53, wherein the lithium-containing salt comprises Nb.

55. The composite of claim 53, wherein the lithium-containing salt comprises Ta.

56. The composite of claim 53, wherein the lithium-containing salt comprises Nb and Ta.

57. The composite of claim 53, wherein the lithium-containing salt is LiNbO₃.

58. The composite of claim 53, wherein the lithium-containing salt is LiTaO3.

59. The composite of claim 53, wherein the layer includes at least two different lithium-containing salts, and the two different lithium-containing salts are LiTaO3 and LiNbO3.

60. A semi-solid state electrolyte comprising the composite of claim 53, wherein the layer is wet with liquid electrolyte.

61. A semi-solid state electrolyte comprising the composite of claim 57, wherein the layer is wet with liquid electrolyte.

62. The semi-solid state electrolyte of claim 61, wherein the liquid electrolyte comprises a lithium salt and an organic solvent.

63. The semi-solid state electrolyte of claim 62, wherein the lithium salt is selected from LiPF6, LiClO4, LiBF4, LiAsF6, LIBOB, LIODFB, LiDFB, LiTFSl, LIFSl, or combinations thereof, and the organic solvent is selected from ethylene carbonate (EC), dimethyl carbonate (DMC), diethyl carbonate (DEC), ethyl methyl carbonate (EMC), propylene carbonate (PC), a carboxylate solvent, a sulfite solvent, a fluorinated solvent, or combinations thereof.

64. The semi-solid state electrolyte of claim 52, wherein the liquid electrolyte comprises a lithium salt and an organic solvent.

65. The semi-solid state electrolyte of claim 60, wherein the lithium salt is selected from LiPF6, LiClO4, LiBF4, LiASF6, LIBOB, LIODFB, LiDFB, LiTFSl, LIFSl, or combinations thereof, and the organic solvent is selected from ethylene carbonate (EC), dimethyl carbonate (DMC), diethyl carbonate (DEC), ethyl methyl carbonate (EMC), propylene carbonate (PC), a carboxylate solvent, a sulfite solvent, a fluorinated solvent, or combinations thereof.

66. A cell comprising an anode, a cathode, and the semi-solid state electrolyte of claim 51.

67. A cell comprising an anode, a cathode, and the semi-solid state electrolyte of claim 53.

68. A semi-solid state electrolyte comprising the composite of claim 47, wherein the layer is wet with liquid electrolyte.

69. A semi-solid state electrolyte comprising the composite of claim 49, wherein the layer is wet with liquid electrolyte.

70. A semi-solid state electrolyte comprising the composite of claim 50, wherein the layer is wet with liquid electrolyte.

71. A semi-solid state electrolyte comprising at least one layer including a mixture of at least one lithium-containing salt and at least one compound according to 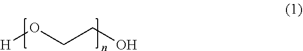
formula
wherein n is an integer from 1 to 100, wherein a weight ratio of the compound according to formula (1) to the lithium-containing salt is 1:100 to 100:1, and may be 1:1 to 1:10.

72. Use of a mixture of at least one lithium-containing salt and at least one compound according to formula (1) 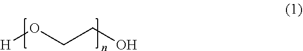
wherein n is an integer from 1 to 100, wherein a weight ratio of the compound according to formula (1) to the lithium-containing salt is 1:100 to 100:1, and may be 1:1 to 1:10; to improve capacity retention in a cell or battery, to reduce lithium deposition, for example to reduce lithium dendrite growth, in a cell or battery, or both.

73. Use according to claim 72, wherein the mixture is applied to a support and optionally wherein the mixture forms part of a semi-solid state electrolyte.

74. A semi-solid state electrolyte comprising the composite of claim 31, wherein the layer is wet with liquid electrolyte.

75. A cell comprising an anode, a cathode, and the semi-solid state electrolyte of claim 47.
